(19) United States
(12) Patent Application Publication
(10) Pub. No.: US 2005/0145447 A1
(43) Pub. Date: Jul. 7, 2005

(54) Energy converting brake system

(75) Inventors: Stan Nowak, Balcatta (AU); Vin C. Morley, Balcatta (AU); Dorota Helena Kieronska, Balcatta (AU)

Correspondence Address: CARSTENS YEE & CAHOON, LLP, P O BOX 802334, DALLAS, TX, 75380, US

(73) Assignee: SAFE EFFECT PTY LTD, Balcatta (AU)

(21) Appl. No.: 10/969,591

(22) Filed: Oct. 20, 2004

(30) Foreign Application Priority Data
Oct. 20, 2003 (AU) 2003905738

(51) Int. Cl. F16D 55/02

(52) U.S. Cl. 188/71.6

(57) ABSTRACT

An energy converting brake system 10 comprises a brake 12 comprising a cooling circuit 18 through which a brake cooling fluid flows. The cooling fluid is passed through heat exchanger 22 which also includes a thermoelectric conversion device 26. Heat from the cooling fluid is dissipated in the heat exchanger 22 through the thermoelectric conversion device 26, which in turn generates an electric current. The electric current can be stored in a storage device 28.

### FIELD OF INVENTION

The present invention relates to an energy conversion system, and in particular, but not exclusively, to an energy conversion system for a vehicle.

### BACKGROUND OF INVENTION

Attempts have been previously made to harness what is otherwise waste energy associated with the driving or motion of a vehicle such as a car, truck or bus. International publication number WO 00/13952 describes an energy management system operable in three modes to either drive or retard a driveshaft of a vehicle, or to have no driving or retarding effect on the driveshaft. The system comprises cylinders which are able to store and release energy through the charging and discharging of a gas, a pump in fluid communication with the cylinders and a reservoir in communication with the pump. The pump is coupled to the driveshaft of the vehicle. When the management system is in the retarding mode, the driveshaft drives the pump to pump gas into the cylinders, thereby increasing the fluid pressure within the cylinders. In the driving mode the system operates to release gas pressure from the cylinders to drive the pump which in turn drives the driveshaft thereby providing additional power to the vehicle.

The present invention has been developed with the view to providing an alternate energy/conversion system which is particularly applicable for use in connection with a vehicle.

### SUMMARY OF THE INVENTION

According to the present invention, there is provided an energy converting brake system comprising:
a brake having a braking surface and a friction surface wherein said surfaces can be selectively moved into contact with each other, and a brake cooling circuit through which a brake cooling fluid flows, said brake cooling circuit being thermally coupled with one or both of said braking surface and friction surface whereby heat generated by mutual contact of said braking surface with said friction surface is transferred to said brake cooling fluid;
a heat exchanger comprising a thermoelectric energy conversion device, said heat exchanger thermally coupled to said brake cooling fluid and arranged so that heat from said brake cooling fluid is dissipated from said brake cooling fluid by transfer through said thermoelectric energy conversion device, said thermoelectric energy conversion device generating an electric current by action of said transfer of heat.

Preferably, said energy converting brake system further comprises a cooling medium and said thermoelectric energy conversion device is thermally coupled between said brake cooling fluid and said cooling medium, said heat transfer being from said brake cooling fluid through said thermoelectric conversion device to said cooling medium.

Preferably, said cooling medium comprises a second fluid.

Preferably, said energy conversion system further comprises a fluid cooling circuit through which said second fluid flows, and wherein said heat exchanger is thermally coupled to said second fluid.

Preferably, said heat exchanger further comprises a flow path through which said second fluid flows when circulating in said fluid cooling current.

Preferably, said energy converting brake system further comprises an electrical energy storage device for storing electrical energy associated with said current.

In one embodiment, said electrical energy storage device comprises a capacitor.

Preferably, the thermoelectric conversion device is a solid state device.

Preferably, said thermoelectric conversion device is a thermotunnel converter.

Preferably, said brake cooling circuit comprises a manifold through which said brake cooling fluid flows said manifold being in thermal contact with one or both of said braking surface and said friction surface.

Preferably, said friction surface is coupled to a rotating body and said braking surface is rotationally fixed, and said manifold is provided with an outer surface constituting said braking surface.

In one embodiment, said brake is a drum brake having one or more brake shoes and a drum fixed to said rotating body, said drum having an inner circumferential surface facing said braking surface, wherein said friction surface is attached to said inner circumferential surface.

However, in an alternate embodiment, said brake comprises a disc brake wherein said friction surface is coupled to said rotating body and said manifold is in the form of a disc or sector of a disc having a surface which constitutes said braking surface.

Preferably, said brake cooling circuit comprises a valve and a bypass branch whereby said valve operates to divert said brake cooling fluid so as to not flow through said heat exchanger when said brake cooling fluid is at a temperature lower than a selected temperature.

Preferably, said brake is a wet brake and further comprises:
a housing in which said braking surface and friction surface are housed; and,
a volume of lubricating liquid contained in said housing for lubricating said friction and braking surfaces.

According to the present invention, there is also provided a vehicle comprising a fossil fuel engine for providing torque to one or more wheels of said vehicle, said fossil fuel engine having an engine cooling circuit through which engine cooling fluid flows for cooling said engine;
an energy converting brake system in accordance with the first aspect of the present invention, said braking system being operable to brake one or more of said wheels; and,
wherein said heat exchanger is in thermal communication with said engine cooling liquid whereby said electric current is generated by heat transferred from both said engine cooling fluid and said brake cooling fluid.

According to the present invention, there is provided a vehicle comprising:
an electric engine for providing torque to one or more wheels of said vehicle;
an energy converting braking system in accordance with the first aspect of the present invention, said braking system being operable to brake one or more of said wheels; and,
an electric circuit for delivering said electric current produced by said thermoelectric conversion device to said electric engine.

According to the present invention, there is provided a hybrid vehicle comprising:
a fossil fuel engine and an electric engine, said engines adapted to provide torque to one or more wheels of said vehicle;
an energy converting brake system in accordance with the first aspect of the present invention, wherein said braking system is connected with one of said wheels;
said engine cooling circuit being in thermal communication with said heat exchanger whereby heat from said engine cooling fluid and said brake cooling fluid is transferred to said second fluid through said solid state energy conversion device to produce said electric current; and,
an electric circuit for delivering said electric current to said electric engine.

Preferably, said electric circuit includes an energy storage device for storing energy associated with said electric current and subsequent delivery of said stored electrical energy to said electric engine.

Throughout this specification, including the claims, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be clearly understood that, although prior art use and publications are referred to herein, this reference does not constitute an admission that any of these form a part of the common general knowledge in the art, in Australia or in any other country.

### BRIEF DESCRIPTION OF THE DRAWINGS

An embodiment of the present invention will now be described by way of example only with reference to the accompanying drawings in which:

FIG. 1 is a schematic representation of an energy conversion system in accordance with an embodiment of the present invention;

FIG. 2 depicts a brake incorporated in an embodiment of the present invention;

FIG. 3 depicts a set of brake shoes incorporated in the brake shown in FIG. 2;

FIG. 4 is a view of section AA of a brake shoe depicted in FIG. 3;

FIG. 5 is a view of section BB of a brake shoe shown in FIG. 3;

FIG. 6 is a section view of a brake incorporated in an alternative embodiment of the energy conversion system;

FIG. 7 is a plan view of a manifold incorporated in the brake shown in FIG. 6; and,

FIG. 8 is a section view of the manifold in the brake depicted in FIG. 6.

### DETAILED DESCRIPTION OF THE PREFERRED EMBODIMENTS OF THE PRESENT INVENTION

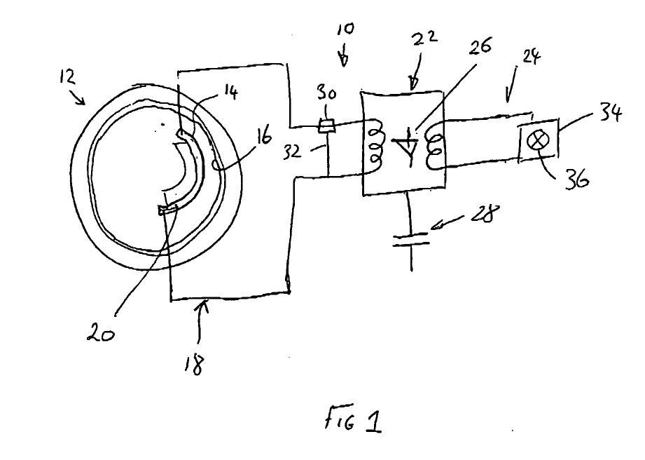

FIG. 1 is a schematic representation of a first embodiment of an energy-converting brake system 10 in accordance with the present invention. The system 10 comprises a brake 12 having a braking surface 14 and a friction surface 16, these surfaces being selectively moveable into contact with each other to produce a braking effect. In this regard, the friction surface 16 rotates relative to the braking surface 14. The brake 12 further comprises a cooling circuit 18 through which a brake cooling fluid flows. The cooling circuit 18 is thermally coupled with the braking surface 14 so that heat generated by the mutual contact of the braking surface 14 with the friction surface 16 is transferred to the brake cooling fluid. In this regard the cooling circuit includes a portion 20 forming part of the braking surface 14. The brake cooling fluid passes through a heat exchanger 22 which also comprises a thermoelectric conversion device 26. Heat from the cooling fluid is dissipated in the heat exchanger 22 through the thermoelectric conversion device 26. The transfer of heat through the device 26 results in the device 26 generating an electric current. Thus, the system 10 is able to generate electrical energy from the heat (thermal) energy produced by the brake 12.

The device 26 is thermally coupled between the brake cooling fluid and a cooling medium that passes through or is thermally coupled with the heat exchanger 22. In a preferred embodiment, the cooling medium is a second fluid that flows through a fluid cooling circuit 24. A portion of the fluid cooling circuit 24 extends through the heat exchanger 22. Accordingly, the heat transfer within the system 10 is as follows. Heat is produced by friction rising from the contact of the braking surface 14 with a friction surface 16. Thus, heat is transferred to the brake cooling fluid, which is circulated by the brake cooling circuit 18 to the heat exchanger 22. Heat from the brake cooling fluid is dissipated through the device 26 to the second fluid. The transfer of heat across the device 26 generates an electric current.

The system 12 can further comprise an electric storage device such as a capacitor 28 for storing electrical energy associated with the electric current. A further electric circuit (not shown) can be used to control the discharge of the capacitor 28 for the purposes of providing controlled use of the stored electrical energy. In one embodiment described hereinafter in greater detail, this current may be used to drive an electric engine of a hybrid vehicle incorporating the brake 12.

The thermoelectric conversion device 26 is advantageously a solid state device and may, for example, take the form of a thermotunnel converter such as a thermotunnel diode or, moreover, an array of such diodes. Such diodes are characterised by having two opposing electrodes separated by a nanometre scale gap across which electrons can tunnel when a sufficient temperature differential is created between the electrodes. Such a temperature differential is provided in the above embodiment by placing one electrode of the diodes 26 in thermal communication with the brake cooling fluid, and the opposite electrode of the diodes in thermal communication with the second fluid circulating through the fluid cooling circuit 24. The tunneling electrons transfer heat from the brake cooling fluid to the second fluid thereby effectively cooling the brake cooling fluid.

The brake cooling circuit 18 can comprise a valve 30 and bypass branch 32 where the valve 30 operates to cause the brake cooling fluid to flow through the branch 32 thereby bypassing the heat exchanger 22 when the temperature of the brake cooling fluid is lower than a selected temperature. Once the selected temperature is reached, the valve 30 switches to allow the brake cooling fluid to flow through the heat exchanger 22, but not through the bypass branch 32.

The fluid cooling circuit 24 may include a radiator 34 to dissipate heat transferred to the second fluid and/or a mechanically or electrically driven fan 36.

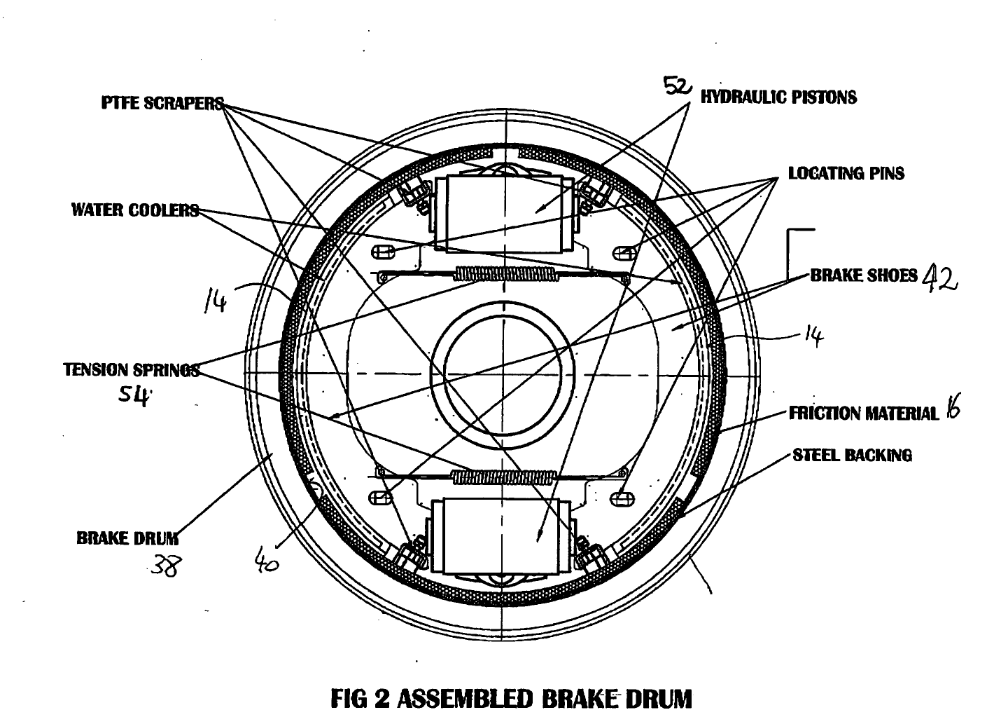

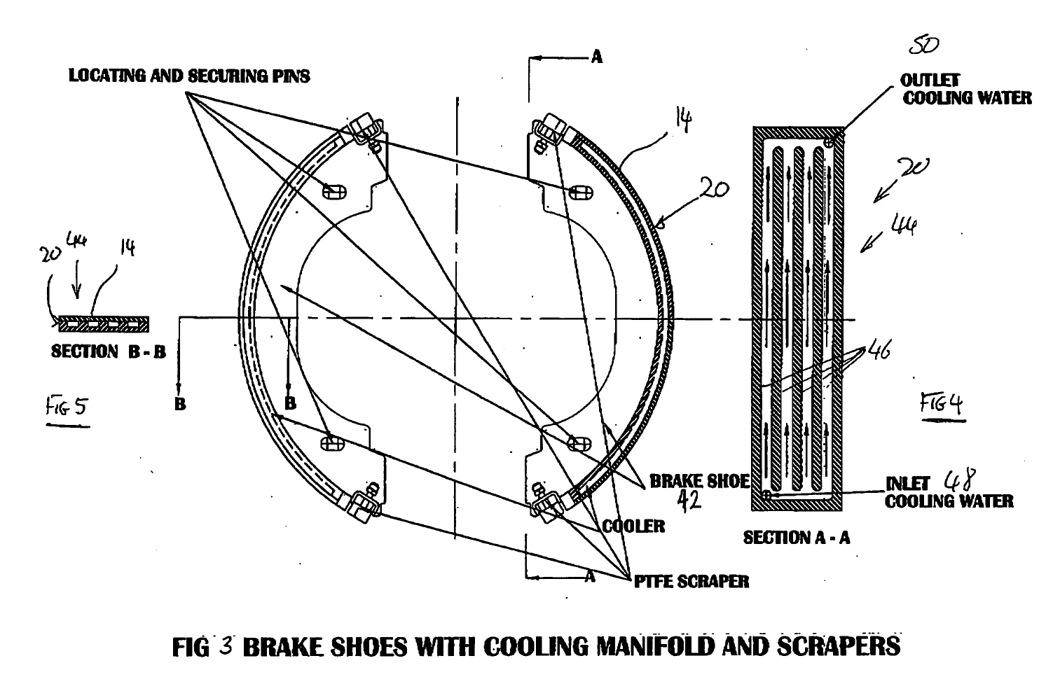

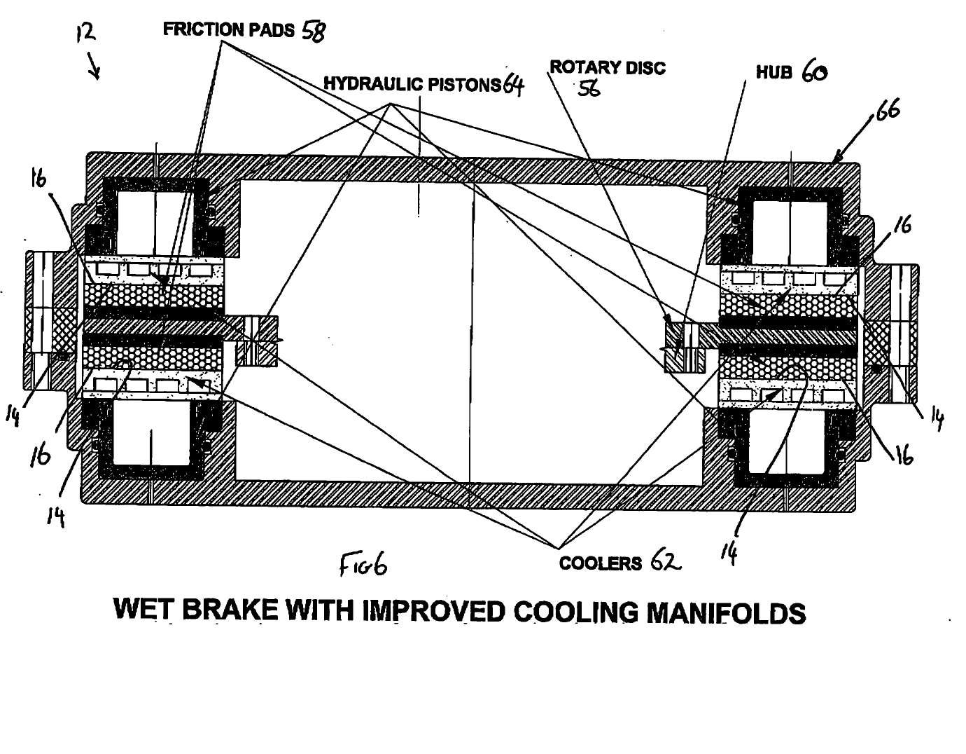

FIGS. 2 to 4 illustrate one form of brake 12 that can be incorporated into the system 10. In this embodiment, the brake 12 is in the form of a drum brake of a type described in Applicant's Australian Patent Application No. 2003904669, the contents of which are incorporated herein by way of reference. The brake system 12 includes a drum 38 having an inner circumferential surface 40 to which is attached three arcuate layers or pads of friction material which are evenly spaced about the surface 40 of the drum 38. The surfaces of the pads constitute the friction surface 16. The brake 12 also comprises a pair of brake shoes 42, each having an outer convex surface constituting the brake surface 14 which face the friction surface 16. The surfaces 14 are outer surfaces of arcuate manifolds 44 which, with reference to FIG. 1, constitute or equate with the portion 20 of the brake cooling circuit 18 through which the brake cooling fluid flows. Each manifold 44 has a plurality of parallel internal channels 46 which communicate with a fluid inlet 48 at one end and a fluid outlet 50 at the opposite end. Thus, the brake cooling fluid in circuit 18 flows through the inlet 48, through the channels 46 and out the outlet 50 en route to the heat exchanger 22. The manifold 44 is made from a metal and thus will have a substantially higher thermal conductivity than the friction pads forming the friction surface 16. When the brake 12 is applied so that the braking surface 14 is in contact with the friction surface 16, the subsequently generated heat will be preferentially conducted through the manifold 44 and to the brake cooling fluid flowing therethrough.

The brake shoes 42 are mounted so as to slide lineally toward and away from the friction material 16 by operation of a pair of spaced-apart hydraulic pistons 52 and a pair of tension springs 54 coupled therebetween. Further, the brake 12 may be manifested as a wet brake in which the drum 38 is disposed within a sealed housing (not shown) which also holds a supply of lubricating liquid for lubricating the braking surface 14 and friction surface 16. In this event, scrapers 55 are provided at opposite ends of each manifold 44 for the purposes of wiping the lubricating fluid from the friction surface 16 during the braking operation. Alternatively, the scrapers can be provided in the space between adjacent layers or pads of friction material to scrape lubricating fluid from the braking surface 14. Further details of the operation of the brake 12 depicted in FIGS. 1 to 4 are provided in the aforementioned incorporated reference, Australian Application No. 2003904669.

FIGS. 6 to 8 depict an embodiment of the brake 12 in the form of a wet disc brake system of the type described in Applicant's Australian Patent Application No. 2003902857, the contents of which are incorporated herein by way of reference. The brake system 12 comprises an annular rotor 56 having opposite radial faces on which friction pads 58 are mounted. The surface of the friction pads 58 constitute the friction surface 16. The rotor 56 is bolted to a wheel hub 60 (only a portion of which is depicted for clarity). On each side of the rotor 56 there is provided an annular manifold 62 through which brake cooling fluid flows. The manifold 62 is equivalent to the portion 20 of the circuit 18 shown in FIG. 1. The surfaces of each of the manifolds 62 facing the friction material 16 constitute the braking surface 14. Hydraulic pistons 64 are provided for selectively moving the manifolds 62 linearly into contact with the rotor 56 so that the braking surfaces 14 engage the friction surfaces 16 to produce a braking effect. The heat generated during this process is conducted by the brake cooling fluid as it flows through the manifolds 62 and the remainder of the brake cooling circuit 18.

A sealed housing 66 encases the braking surface 14 and friction surface 16, supports the pistons 64, and contains a volume of lubricating liquid (not shown) for lubricating the braking and friction surfaces 14 and 16. A rotary seal (not shown) on one side of the housing 66 enables the hub 60 to extend therethrough, while a rotary seal (not shown) on an opposite side of the housing 66 enables connection of the hub 60 with a vehicle wheel (not shown).

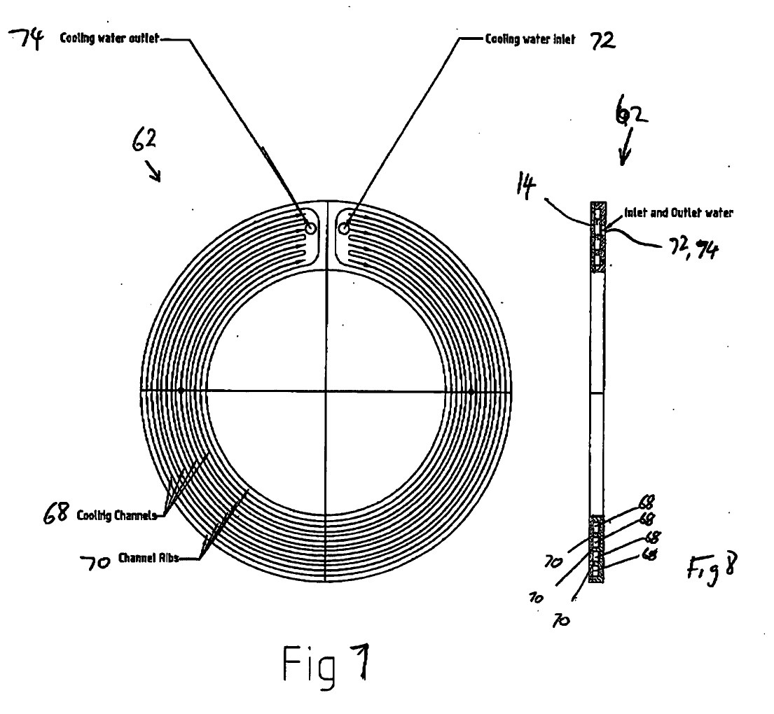

With particular reference to FIGS. 7 and 8, it can be seen that the manifold 62 is formed with a plurality of internal arcuate channels 68 spaced apart by parallel ribs 70. The channels 68 communicate at one end with a fluid inlet 72 and at an opposite end with a fluid outlet 74. Thus, the brake cooling fluid in circuit 18 flows through the inlet 72, through the channels 68 and out the outlet 74 en route to the heat exchanger 22. As in the previously described embodiment, the manifold 62 is made from a metal and therefore has substantially higher thermal conductivity than the friction pads 58 so that the heat generated by braking will be preferentially transferred into the manifold 62 and subsequently to the brake cooling fluid flowing through the circuit 18.

Further mechanical and operational details of the brake 12 are described in the aforementioned incorporated reference, Australian Application No. 2003902857.

The braking system 12 may be incorporated into either a conventional vehicle having a fossil fuel engine or alternatively a hybrid vehicle having a fossil fuel engine and an electric engine, where the brake 12 is associated with one or more wheels of the vehicle so that when the brake 12 is operated, heat generated by the brake of the vehicle is used to generate an electric current which can be subsequently used to provide power assistance to the vehicle or indeed any other purpose. Moreover, when the system 10 is used in conjunction with a hybrid vehicle, the electric energy stored in the capacitor 28 can be discharged selectively via an electrical circuit (not shown) to provide additional power to the electric engine, for example, at times of acceleration or heavy load.

Further, the vehicle, be it a conventional vehicle or a hybrid vehicle, will include usually an engine cooling circuit, typically in the form of a radiator, water jacket and water pump, circulating a coolant such as glycol through the jacket. The embodiments of the present system 10 can be modified so that the engine cooling fluid can also be channeled through the heat exchanger 22 to provide an additional source of heat for generating further electric current. The brake cooling fluid and engine cooling fluid will remain separate, though heat from both transferred via the heat exchanger 22 and through the solid state thermoelectric conversion device 26 to the cooling circuit 24. In order to manage the heat transfer, the heat exchanger 22 can be scaled up as required or alternatively a plurality of heat exchangers 22 may be provided in thermal communication with the brake cooling circuit 18 and/or the engine cooling circuit, and either a common scaled-up cooling circuit 24 or individual cooling circuits 24. The current generated by each of the heat exchangers 22 can be either stored in separate storage devices 28 or fed to a common larger storage device.

In addition, if desired, a heat trap or heat store can be provided which contains a large volume of liquid that is heated by thermal conduction from the brake cooling fluid and engine cooling fluid, the heat store then used to transfer heat to the heat exchanger 22.

All modifications and variations in the embodiments described in the above invention that will be obvious to a person skilled in the art are deemed to be within the scope of the present invention, the nature of which is to be determined from the above description and the appended claims.

1. An energy converting brake system comprising:
a brake having a braking surface and a friction surface wherein said surfaces can be selectively moved into contact with each other, and a brake cooling circuit through which a brake cooling fluid flows, said brake cooling circuit being thermally coupled with one or both of said braking surface and friction surface whereby heat generated by mutual contact of said braking surface with said friction surface is transferred to said brake cooling fluid;
a heat exchanger comprising a thermoelectric energy conversion device, said heat exchanger thermally coupled to said brake cooling fluid and arranged so that heat from said brake cooling fluid is dissipated from said brake cooling fluid by transfer through said thermoelectric energy conversion device, said thermoelectric energy conversion device generating an electric current by action of said transfer of heat.

2. The energy converting brake system according to claim 1 further comprising a cooling medium and said thermoelectric energy conversion device is thermally coupled between said brake cooling fluid and said cooling medium, said heat transfer being from said brake cooling fluid through said thermoelectric conversion device to said cooling medium.

3. The energy converting brake system according to claim 2 wherein said cooling medium comprises a second fluid.

4. The energy converting brake system according to claim 3 further comprising a fluid cooling circuit through which said second fluid flows, and wherein said heat exchanger is thermally coupled to said second fluid.

5. The energy converting brake system according to claim 1 further comprising an electrical energy storage device for storing electrical energy associated with said current.

6. The energy converting brake system according to claim 5 wherein said electrical energy storage device comprises a capacitor.

7. The energy converting brake system according to claim 1 wherein the thermoelectric conversion device is a solid state device.

8. The energy converting brake system according to claim 1 wherein said thermoelectric conversion device is a solid state thermotunnel converter.

9. The energy converting brake system according to claim 1 wherein said brake cooling circuit comprises a manifold through which said brake cooling fluid flows, said manifold being in thermal contact with one or both of said braking surface and said friction surface.

10. The energy converting brake system according to claim 9 wherein said friction surface is coupled to a rotating body and said braking surface is rotationally fixed, and said manifold is provided with an outer surface constituting said braking surface.

11. The energy converting brake system according to claim 10 wherein said brake is a drum brake having one or more brake shoes and a drum fixed to said rotating body, said drum having an inner circumferential surface facing said braking surface, wherein said friction surface is attached to said inner circumferential surface.

12. The energy converting brake system according to claim 10 wherein said brake comprises a disc brake wherein said friction surface is coupled to said rotating body and said manifold is in the form of a disc or sector of a disc having a surface which constitutes said braking surface.

13. The energy converting brake system according to claim 1 wherein said brake is a wet brake and further comprises:
a housing in which said braking surface and friction surface are housed; and,
a volume of lubricating liquid contained in said housing for lubricating said friction and braking surfaces.

14. The energy converting brake system according to claim 1 wherein said brake cooling circuit comprises a valve and a bypass branch whereby said valve operates to divert said braking cooling fluid so as to not flow through-said heat exchanger when said brake cooling fluid is at a temperature lower than a selected temperature.

15. A vehicle comprising a fossil fuel engine for providing torque to one or more wheels of said vehicle, said fossil fuel engine having an engine cooling circuit through which engine cooling fluid flows for cooling said engine;
an energy converting brake system in accordance with claim 1, said braking system being operable to brake one or more of said wheels; and,
wherein said heat exchanger is in thermal communication with said engine cooling liquid whereby said electric current is generated by heat transferred from both said engine cooling fluid and said brake cooling fluid.

16. A vehicle comprising:
an electric engine for providing torque to one or more wheels of said vehicle;
an energy converting brake system in accordance with claim 1, said braking system being operable to brake one or more of said wheels; and,
an electric circuit for delivering said electric current produced by said thermoelectric conversion device to said electric engine.

17. A hybrid vehicle comprising:
a fossil fuel engine and an electric engine, said engines adapted to provide torque to one or more wheels of said vehicle;
an energy converting brake system in accordance with claim 1, wherein said braking system is connected with one of said wheels;
said engine cooling circuit being in thermal communication with said heat exchanger whereby heat from said engine cooling fluid and said brake cooling fluid is transferred to said second fluid through said solid state energy conversion device to produce said electric current; and,
an electric circuit for delivering said electric current to said electric engine.

18. The vehicle according to claim 17 wherein said electric circuit includes an energy storage device for storing energy associated with said electric current and subsequent delivery of said stored electrical energy to said electric engine.
